(19) United States
(12) Patent Application Publication
(10) Pub. No.: US 2013/0341907 A1
(43) Pub. Date: Dec. 26, 2013

(54) TOOL FOR DRAWING A SLEEVE ONTO FLANGES AND REMOVING SAID SLEEVE FROM FLANGES, POSITIONING DEVICE, TOOL ARRANGEMENT AND METHOD

(71) Applicant: AIRBUS OPERATIONS GMBH, Hamburg (DE)

(72) Inventor: Wilhelm Lutzer, Zarpen (DE)

(21) Appl. No.: 13/921,863

(22) Filed: Jun. 19, 2013

Related U.S. Application Data
(63) Continuation of application No. PCT/EP2011/072962, filed on Dec. 15, 2011.
(60) Provisional application No. 61/426,058, filed on Dec. 22, 2010.

(30) Foreign Application Priority Data
Dec. 22, 2010 (DE) 10 2010 063 988.5

(51) Int. Cl. B25B 27/10; F16L 23/00

(52) U.S. Cl. CPC B25B 27/10; F16L 23/003
USPC 285/39

(57) ABSTRACT

The invention relates to a tool, in particular for the aerospace industry, for drawing a sleeve onto flanges and removing said sleeve from flanges of a pipe arrangement substantially along an axis of the flanges, including a retaining means which has a first effective surface for acting on the sleeve in a first direction; a pressure means which has a second effective surface for acting on the pipe arrangement in a second direction opposite the first direction; and an actuating means for moving the first effective surface in the first direction and for moving the second effective surface in the second direction.

### CROSS-REFERENCE TO RELATED APPLICATIONS

This application is a continuation of and claims priority to PCT/EP2011/072962 filed Dec. 15, 2011, which claims the benefit of and priority to U.S. Provisional Application No. 61/426,058, filed Dec. 22, 2010, and German patent application No. 10 2010 063 988.5, filed Dec. 22, 2010, the entire disclosures of which are herein incorporated by reference.

### FIELD OF THE INVENTION

The present invention relates to a tool for drawing a sleeve onto flanges and removing said sleeve from flanges, in particular for the aerospace industry, to a positioning device, a tool arrangement and a method.

Although the present invention and the problem addressed thereby can be applied to any pipes, they will be described in detail with respect to Hydraflow® type couplings and associated pipes in an aircraft.

### BACKGROUND OF THE INVENTION

Fluid-conducting pipelines in aircraft are frequently connected by flexible quick connectors, in particular of the Hydraflow® type. Couplings of this type allow interconnected pipes to be offset longitudinally and at an angle.

### SUMMARY OF THE INVENTION

FIGS. 1A and 1B are perspective views of an exemplary pipe arrangement 1 with such a Hydraflow® type quick coupling.

In FIG. 1A, the pipe arrangement 1 is shown in a dismantled state. The pipe arrangement comprises a first pipe 2 and a second pipe 3. The pipes 2, 3 are, for example, components of a waste water line system of an aircraft. The pipes 2 and 3 are provided in each case with a first coupling element 4 and a second coupling element 5. The coupling elements 4, 5 are of an annular construction, a rotationally-symmetrical first flange 6 and second flange 7 being configured on the end of the respective coupling element 4, 5 remote from the respective pipe 8, 9. The flanges 6, 7 are each provided on their periphery with a groove 6a, 7a in which a seal configured as an O ring 8, 9 is arranged.

During assembly of the pipe arrangement 1, the coupling elements 4, 5 are initially pushed onto pipe ends 2a, 3a. They are then secured thereon in a material-bonding manner, a form locking manner and/or a friction locking manner, for example by welding or widening the pipes or rolling into the pipes.

A sleeve 11 is then pushed over the first flange 6 along a longitudinal axis X of the first flange 6 which forms the rotational symmetry axis of said first flange 6. In so doing, the O ring 8 is elastically deformed. The sleeve 11 is drawn over the first flange 6 until an end face 11b of the sleeve 11 approximately aligns with an end face 6c of the flange 6. In a further step, an end face 7c of the second flange 7 is arranged such that it rests against the end face 6c of the first flange 6. The sleeve 11 is then drawn over the second flange 7, the O ring 9 being squeezed until the end face 11b of the sleeve approximately aligns with the rear side 7b of the second flange 7.

The pipe arrangement is then disposed as shown in FIG. 1B. The sleeve which has been pushed over the O rings 8, 9 provides a tight pipe connection. A clamp 12 is then strapped, i.e. attached in a releasable manner, around the sleeve 11 in the peripheral direction thereof. The clamp 12 prevents the sleeve from sliding off the flanges 6, 7 along the longitudinal axis X.

Drawing the sleeve onto and removing the sleeve from the flanges requires a considerable expenditure of force. To achieve a satisfactory sealing effect of the O rings, they have to be squeezed between the flanges and the sleeve with a predetermined pressure. For this purpose, the internal diameter of the sleeve is configured to be smaller than the external diameter of the O rings.

At present, the assembly and disassembly, i.e. drawing on and removing sleeves of this type is carried out manually. It is practically impossible to prevent the sleeve from tilting during manual assembly and disassembly which, in turn, means that more force is required. From an ergonomical point of view, this is unfavourable in particular for frequent maintenance work, as is typical in the field of aviation, and can lead to a prolonged assembly and disassembly time.

The sleeves are typically very thin and are thus configured with sharp edges. This presents a hazard to the O rings which can be damaged as a result of the assembly of the sleeves.

Assembly and disassembly of the sleeves is also often carried out using screwdrivers and hammers, which can result in damage to the coupling and/or to the O rings as well.

A further problem is that, before being mounted, the O rings often have to be greased to reduce the friction resistance, so that manual assembly and disassembly is even possible at all. However, for some uses, for example in fresh water systems, greasing is prohibited since it can result in microbial contamination.

An idea of the present invention is to provide an approach which allows the sleeve to be drawn onto the flanges and removed from the flanges in a simple manner, where damage to the O rings during assembly and disassembly of the sleeve is prevented.

The fundamental idea of the present invention is to provide a tool for drawing a sleeve onto flanges and removing said sleeve from flanges of two pipes along an axis of the flanges, which tool comprises a retaining means which has a first effective surface for acting on the sleeve in a first direction, a pressure means which has a second effective surface for acting on the pipe arrangement in a second direction opposite the first direction, and an actuating means for moving the first effective surface in the first direction and for moving the second effective surface in the second direction.

Thus, the present invention has the advantage that a force for drawing on and removing the sleeve is applied by a tool. The sleeve is prevented from tilting relative to the flanges during the drawing on and removal operations in that the first effective surface and the second effective surface move in exactly opposite directions. This greatly reduces the expenditure, of force required for drawing on and removing the sleeve. Since a tilting action is prevented, the risk of damage to the O rings is also greatly reduced.

Advantageous configurations and improvements of the invention are provided in the subclaims.

In the present context, the term “flange” is understood as meaning in particular a disc-shaped ring element. The longitudinal axis of a flange passes through the centre of the ring element, perpendicular to its surfaces.

According to a preferred development of the invention, the second effective surface is configured to act on at least one of the flanges and/or on at least one pipe of the pipe arrangement. Pipe flanges of this type typically extend in the radial direction to the pipe axis and thus form a contact surface parallel to the second effective surface. It is therefore particularly easy to apply a force onto the contact surface of the flange by means of the second effective surface and to thus produce a counterforce to the force which acts on the sleeve by means of the first effective surface, thereby allowing the sleeve to be drawn onto and removed from the flanges. A further very suitable point of application is formed by one of the pipes of the pipe arrangement itself. For example, the second effective surface can be arranged on a body, for example on a clamp which is attached, preferably releasably, on the pipe in a friction and/or form-locking manner. This also ensures that a counterforce is easily produced for drawing on the sleeve or removing it from the flanges.

An embodiment provides that the first and/or second effective surface is configured to act on the sleeve and on the pipe arrangement by form locking and/or force locking, in particular by friction locking.

In a further preferred embodiment of the invention, the first effective surface is configured to be curved with an inner radius and/or the second effective surface is configured to be curved with an outer radius. This allows the largest possible surface contact between the effective surfaces of the tool and the corresponding surfaces on which the first and/or second effective surface acts. This is due to the fact that flanges and pipes typically have rounded surfaces.

According to a further preferred embodiment, the inner radius of the first effective surface is configured to be greater than the outer radius of the second effective surface. The inner radius and the outer radius preferably originate in a centre point of the flange. This provides the advantage that the first effective surface can move over the second effective surface. The sleeve can thus be pushed over the second effective surface by the first effective surface. Therefore, the tool for drawing on and removing sleeves in the axial direction of the flanges or of the pipes of the pipe arrangement requires a small amount of space. This is advantageous particularly in the confined spatial relations in the field of aviation. Thus overall, the tool can be configured to be relatively small.

According to a further preferred embodiment of the invention, the retaining means comprises a shell mould for at least partially engaging around the sleeve in the peripheral direction thereof. The pressure means also preferably comprises a shell mould for at least partially engaging around the pipe arrangement, i.e. for example around the pipes or flanges, in the peripheral direction thereof. The first and/or second effective surface can be easily made on shell moulds of this type. In this respect, a periphery of the shell moulds preferably has a central angle of more than 180°. This allows a secure engagement around the sleeve and/or pipe arrangement, preventing a possible tilting of the sleeve when the sleeve is drawn onto the flanges or removed therefrom.

In a further preferred embodiment, the shell mould has a plurality of separate effective portions which are coupled together. Consequently, the shell mould, which has the first or second effective surface, is not configured as a closed surface, but for example in the manner of a comb, where only the teeth of the comb form the first or second effective surface. In this respect, the teeth can also be of different lengths. This provides the advantage that the shell mould and thus the first or second effective surface can also act on irregularly formed flanges and/or pipes.

The first effective surface is preferably always arranged parallel to the second effective surface. This can effectively prevent the sleeve from tilting relative to the pipe arrangement and can thus allow a drawing on or removal procedure with a smaller expenditure of force.

According to a further embodiment of the invention, the first effective surface is configured as a contact surface for the sleeve in the first direction and/or the second effective surface is configured as a contact surface for the pipe arrangement in the second effective direction. A contact surface of this type is a simple constructive means for achieving a positive locking between the retaining means and the sleeve and between the pressure means and the pipe arrangement.

Furthermore, it is preferred for the retaining means to be provided with a groove and/or recess for engagement with the sleeve. In this respect, the sleeve is in contact with the groove preferably on its two end faces and/or on its outer periphery. A torque which acts on the sleeve vertically to the longitudinal axis of the sleeve when the sleeve is drawn onto or removed from the flanges can thus be absorbed in the retaining means. The retaining means can thus also be configured with a central angle of significantly less than 180° and therefore can be configured in a relatively space-saving manner.

According to a further preferred embodiment of the invention, the retaining means has a releasable attachment mechanism for releasably attaching the retaining means to the sleeve. The pressure means can preferably also have a releasable attachment mechanism for releasably attaching the pressure means to the pipe arrangement. A releasable attachment mechanism of this type, for example in the form of a clamp which can be tensioned by spring force, allows the tool to be operated in a simple manner, because the tool can now no longer slip off from the sleeve or from the pipe arrangement in the radial direction.

The retaining means and/or the pressure means preferably comprises a resilient material, in particular a spring steel and/or a plastics material. This is particularly advantageous when the retaining means and/or the pressure means has a central angle which is slightly greater than 180°, for example 180.1° to 190°. The retaining means and/or the pressure means can then be resiliently expanded on the sleeve or the pipe arrangement, which ensures a secure connection of the retaining means and/or pressure means in a transverse direction to the first and second effective directions.

The flanges are each typically provided on their periphery with a groove in which an O ring is arranged. When the sleeve is drawn onto the flanges, the O ring which, in its relaxed state, has a greater circumference than an inner circumference of the sleeve, has to be squeezed between the sleeve and the groove of the flange. For this reason, the retaining means is preferably bevelled on an inner periphery on at least one of its end faces.

The bevel on the inner periphery of the retaining means thus acts as an introduction aid for introducing the portion of the O ring protruding above the sleeve between the sleeve and the groove in the flange while the sleeve is drawn onto the flanges.

According to a preferred development of the invention, the tool comprises a guide means, by which the first and second effective surfaces can be moved in the first and second directions. In this respect, the guide means ensures that the first and second effective surfaces move in exactly opposite directions. This can prevent the sleeve from tilting relative to the pipe arrangement.

The guide means preferably has a linear guidance, with corresponding guide elements being attached to the retaining means and the pressure means. Corresponding linear guide elements of this type are, for example, grooves and webs which engage in one another. Another possibility is to provide rails or balls which run in grooves in the retaining means and in the pressure means and only allow a linear movement of the retaining means relative to the pressure means.

Alternatively, the guide means can comprise a parallelogram mechanism and/or a slider mechanism which can be actuated by an actuating means, the parallelogram mechanism and/or slider mechanism being coupled with the retaining means and the pressure means. Here as well, the guide means ensures an exactly opposite movement of the retaining means relative to the pressure means and thus of the first effective surface to the second effective surface. A tilting action, with an associated greater expenditure of force for drawing the sleeve onto and removing it from the flanges is thus prevented.

According to a preferred embodiment, the actuating means comprises a hydraulic system, a pneumatic system, an electromagnet, a mechanical gear reduction and/or handles for the application of force by an operator. All of these embodiments allow a simple and, in particular, also an automated drawing of the sleeve onto the flanges and the removal thereof. The handles for the application of force are preferably configured such that they can be actuated by one hand of an operator. The other hand can be used, for example, to hold the pipe arrangement.

In a further embodiment of the invention, for example the first effective surface for acting on the sleeve and/or the second effective surface for acting on the pipe arrangement can be provided by friction locking. In this respect, the retaining means and/or the pressure means are preferably configured by suitable clamps which engage around the sleeve and pipe arrangement, resting against them firmly at least in portions and thus producing a friction locking between the respective clamp and the sleeve or pipe arrangement.

A preferred development provides that the shell mould of the retaining means and/or of the pressure means can be exchanged, a dovetail joint being provided, for example, for this exchange. Consequently, different shell moulds can be used depending on the diameter of the pipes and sleeves.

A preferred development provides that the first positioning means and the pressure means are configured to be integrated into one another and the retaining means is preferably provided between the first and second positioning means. This advantageously provides a compact device, which on the one hand can carry out the positioning of the pipes and flanges relative to one another and on the other, can perform the drawing on and removal of the sleeves.

A preferred development provides that the first and/or second positioning means comprises a tensioning mechanism by which the first and/or second pipe or coupling elements of the first and/or second pipe can be tightened against a shell mould of a respective positioning means. The pipes and flanges can thus be easily positioned relative to one another.

A preferred development provides that the tensioning mechanism comprises a belt, a chain, a clamp and/or a lever for tensioning the belt, chain or clamp. The lever preferably forms a top dead centre mechanism together with the belt, chain or clamp.

A preferred development provides that the first and second positioning means are rigidly interconnected along the axis by the guide means, the retaining means being provided such that it can move along the axis by the guide means. The guide means is thus advantageously accorded a double function: firstly, it guides the retaining means and secondly, it fixes the first and second positioning means relative to one another.

A preferred development provides that the guide means is configured as a rail which rigidly interconnects the first and second positioning means along the axis, the retaining means being mounted such that it can move on the rail along the axis. This provides a simple construction.

A preferred development provides that the retaining means can move along the rail as the result of actuation by the actuating means, in particular by a spindle, with respect to the two positioning means. Consequently, the retaining means can be moved in a simple manner along the rail. The spindle can preferably be connected or is connected to a drive means, in particular to an electric drive or to a pneumatic drive.

### BRIEF DESCRIPTION OF THE DRAWINGS

In the following, the invention will be described in more detail on the basis of embodiments with reference to the accompanying figures of the drawings, in which:

FIG. 1A is a perspective view of an example of a pipe arrangement in a dismantled state;

FIG. 1B is a perspective view of the example of FIG. 1A in an assembled state;

FIG. 2A is a plan view of a tool according to a first embodiment of the present invention;

FIG. 2B is a cross-sectional view along line A-A from FIG. 2A;

FIG. 2C is a view in the direction of arrow B from FIG. 2A;

FIG. 2D is a view in the direction of arrow C from FIG. 2A;

FIG. 3A is a plan view of a use of the tool according to the first embodiment;

FIG. 3B is a view in the direction of arrow F from FIG. 3A;

FIG. 4 is a plan view of a tool according to a second embodiment of the present invention;

FIG. 5 is a plan view of a tool according to a third embodiment of the present invention;

FIG. 6 is a perspective and very schematic view of a positioning device according to an embodiment of the present invention;

FIG. 7 is a perspective and very schematic view of a tool arrangement according to an embodiment of the present invention;

FIG. 8A is a side view of a tool arrangement according to a further embodiment of the present invention;

FIG. 8B is a view in the direction of arrow G from FIG. 8A;

FIG. 9A is a plan view of a tool arrangement according to a further embodiment of the present invention in a first position; and

FIG. 9B is the view of FIG. 9A, but with the tool arrangement in a second position.

In the figures, identical reference signs denote identical or functionally identical components, unless indicated otherwise.

### DETAILED DESCRIPTION OF THE INVENTION

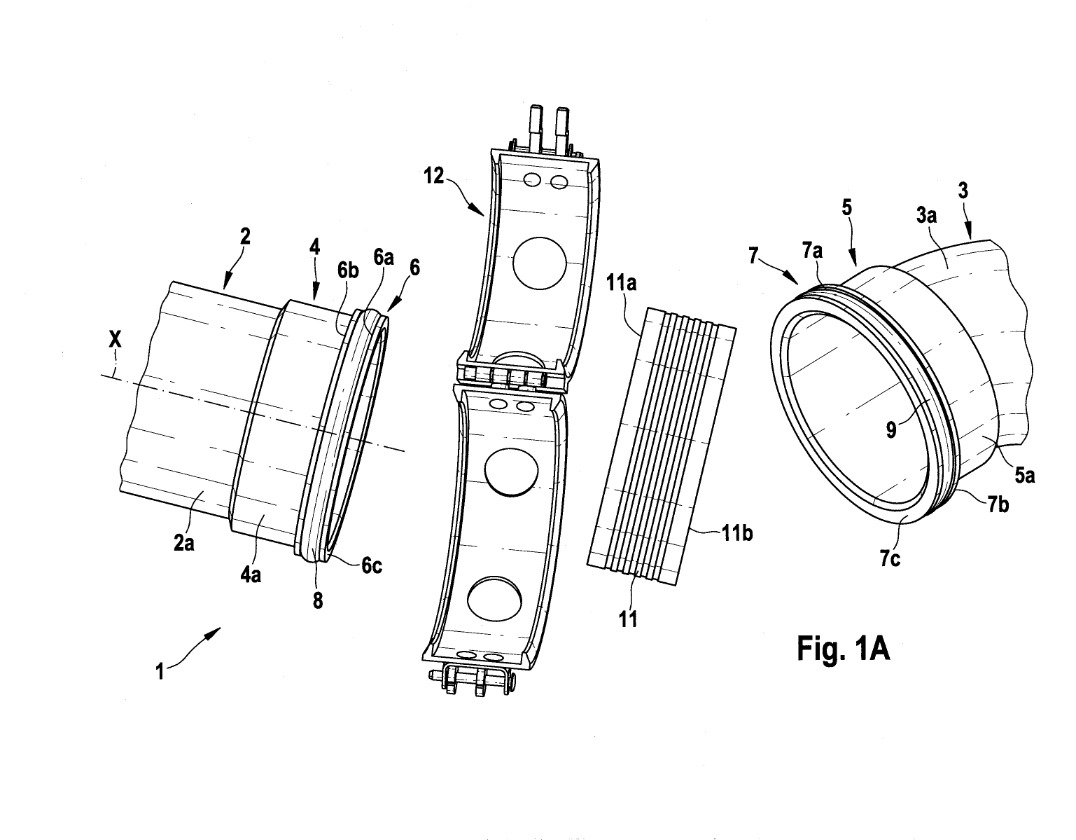

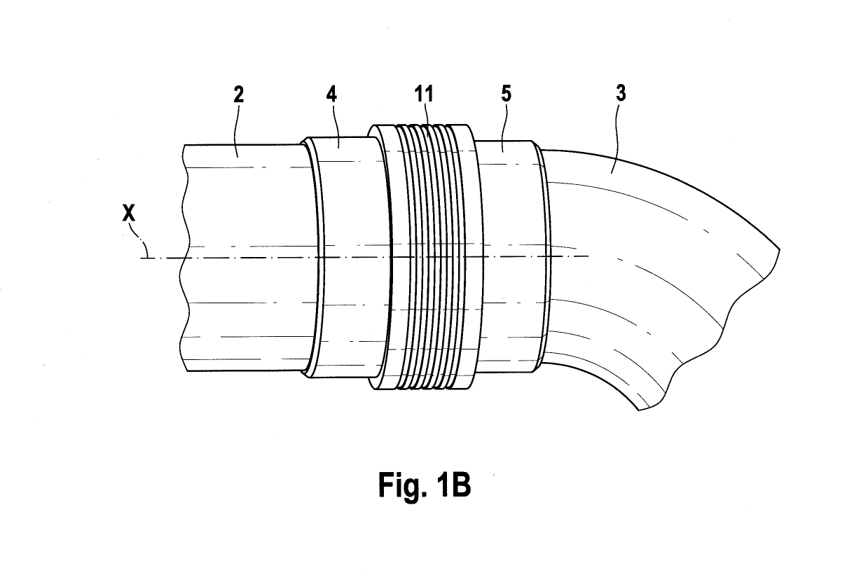

In the following, the drawing of the sleeve 11 onto the flanges 6, 7 and the removal of the sleeve 11 from said flanges 6, 7 (of the pipe arrangement 1 shown in FIGS. 1A and 1B) by means of a tool is described according to various embodiments of the present invention.

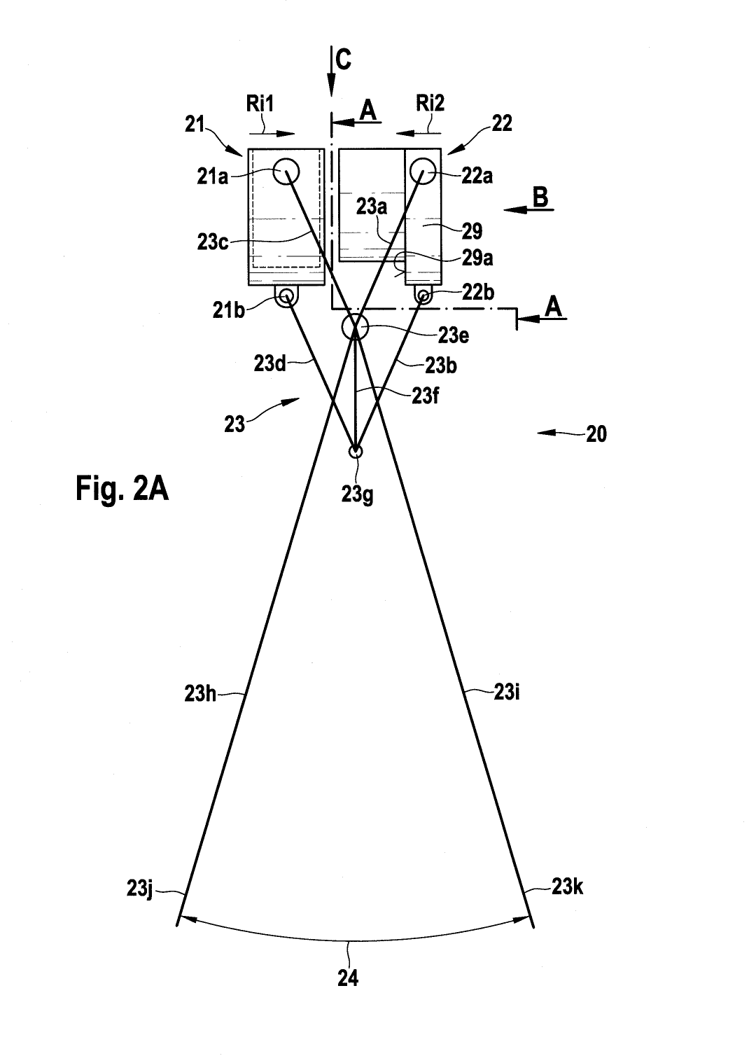

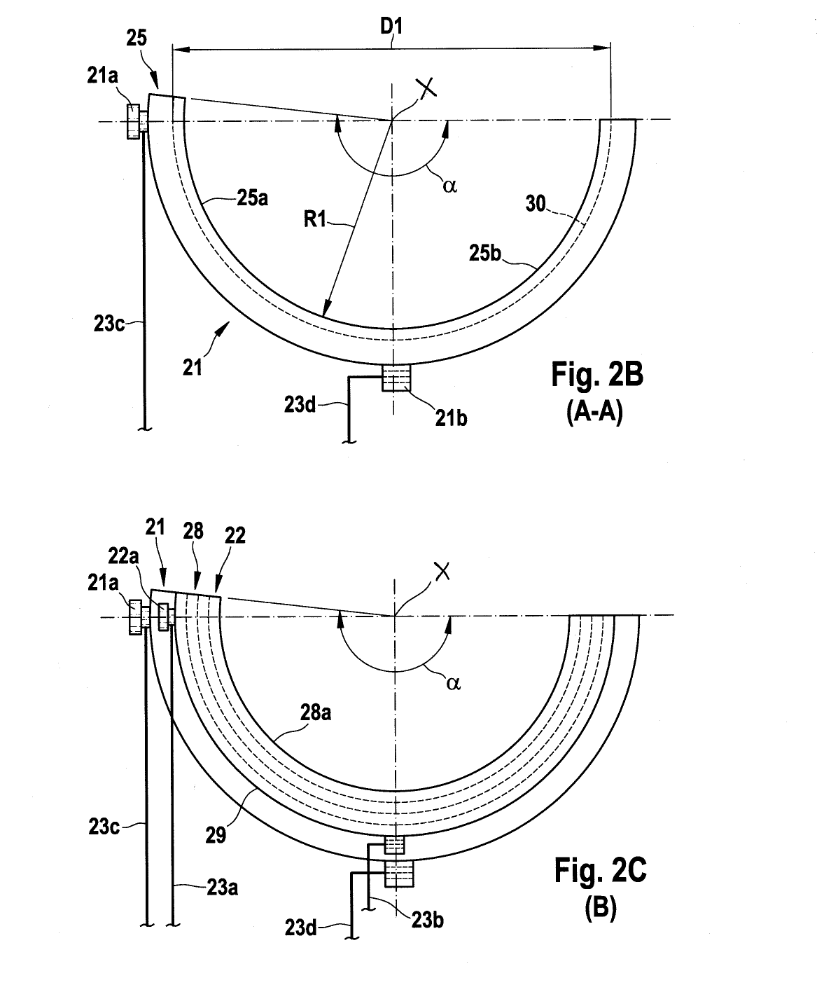

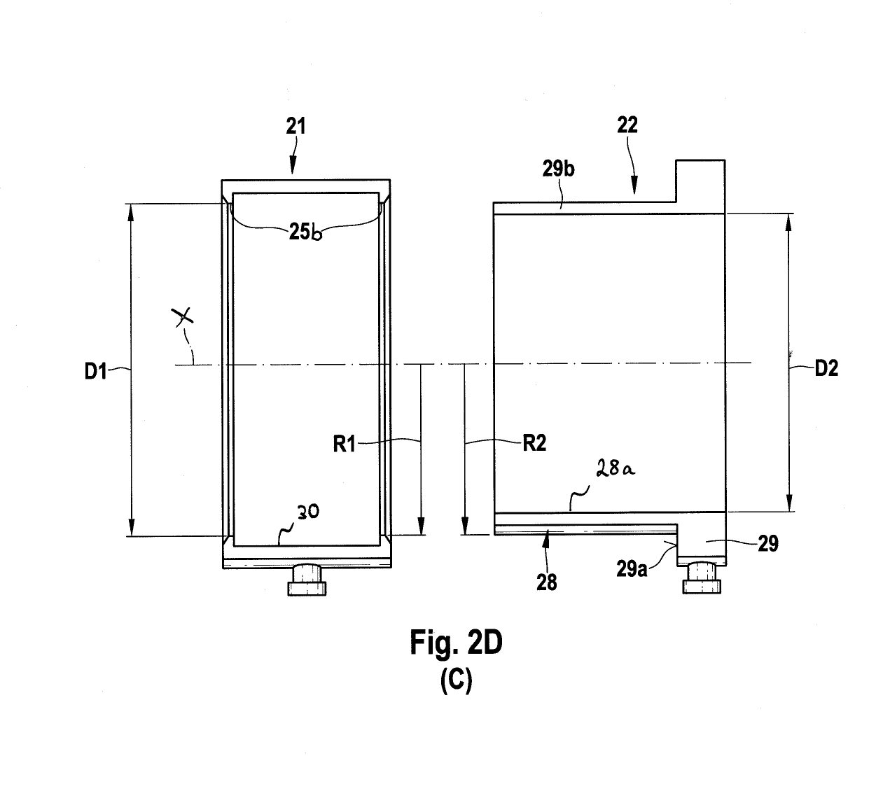

FIG. 2A is a plan view of a tool according to a first embodiment of the present invention. FIGS. 2B, 2C and 2D show views A-A, B and C from FIG. 2A.

The tool 20 comprises a retaining means 21 and a pressure means 22. The retaining means 21 and the pressure means 22 can preferably be moved by a parallelogram mechanism 23 which is merely shown schematically, the retaining means 21 being movable in a first direction Ri1 and the pressure means 22 being movable in a second direction Ri2 which is opposite the first direction Ri1. The parallelogram mechanism 23 has elements 23a, 23b and 23c, 23d which are respectively parallel.

Element 23a is pivotably attached by one end to a first attachment point 22a of the pressure means 22 and by its other end to a first attachment point 23e of a further element 23f of the parallelogram mechanism 23. Element 23b is pivotably attached by one end to a second attachment point 22b of the pressure means 22 and by its other end to a second attachment point 23g of the further element 23f of the parallelogram mechanism 23.

Element 23c of the parallelogram mechanism 23 is pivotably attached to the retaining means 21 at a first attachment point 21a and is pivotably attached to the first attachment point 23e of the further element 23f by its other end. Element 23d is pivotably attached by one end to a second attachment point 21b of the retaining means 21 and by its other end to the second attachment point 23g of the further element 23f of the parallelogram mechanism 23.

Furthermore, the parallelogram mechanism 23 comprises levers 23h, 23i, lever 23h being rigidly connected to element 23a and lever 23i being rigidly connected to element 23c. The levers 23h, 23i can be pivoted relative to one another about the first attachment point 23e (indicated by the double arrow 24). The levers can perform the pivoting movement, indicated by the double arrow 24, by means of a hydraulic system, a pneumatic system, an electric drive, a mechanical gear reduction and/or by handles 23j, 23k for the application of force by an operator.

If the levers 23h, 23i of the parallelogram mechanism 23 are pivoted towards one another, the retaining means 21 and the pressure means 22 move towards one another. Likewise, the levers 23h, 23i can be pivoted away from one another, in which case the retaining means 21 and the pressure means 22 move away from one another.

The retaining means 21 preferably comprises a shell mould 25, as illustrated in FIG. 2B. The shell mould 25 has an inner periphery 25a with a central angle α of preferably approximately 181°. The inner periphery 25a of the shell mould 25 has an inner radius R1.

The shell mould 25 extends in the longitudinal direction along a longitudinal axis X vertically to the paper plane. Furthermore, the shell mould 25 is preferably provided with a groove 30, running on an inner side 25b of the shell mould 25 in the peripheral direction. The groove 30 preferably has a rectangular cross section and is used to receive the sleeve 11. In this respect, an internal diameter D1 (shown in FIG. 2B) of the groove 30 approximately corresponds to an external diameter of the sleeve 11.

In FIG. 2C, the pressure means 22 is arranged upstream of the retaining means 21, seen in the longitudinal direction L. For reasons of clarity, the flange 29 of the pressure means 22 has been shown on a smaller scale.

The pressure means 22 preferably also comprises a shell mould 28 with an inner periphery 28a and the central angle α.

Furthermore, the shell mould 28 of the pressure element 22, as shown in FIG. 2D, is preferably provided with the flange 29 which extends in the radial direction to the longitudinal axis X. The flange 29 has a stop face 29a. An annular portion 29b of the shell mould 28 has an outer radius R2. The outer radius R2 is configured to be smaller than the inner radius R1 of the inner periphery 25a of the shell mould 25 of the retaining element 21. An internal diameter D2 of the shell mould 28 of the annular portion 29b is preferably configured to receive the external diameter of the annular portion 4a, 5a of the coupling elements 4, 5 (see FIG. 1A).

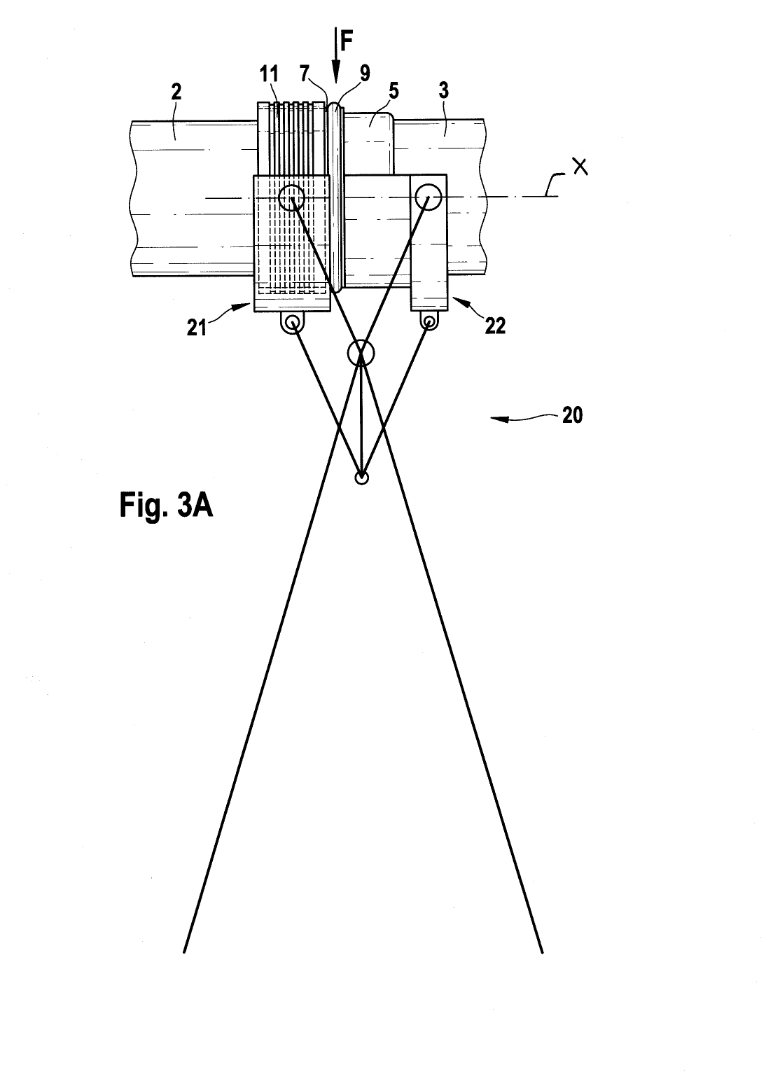

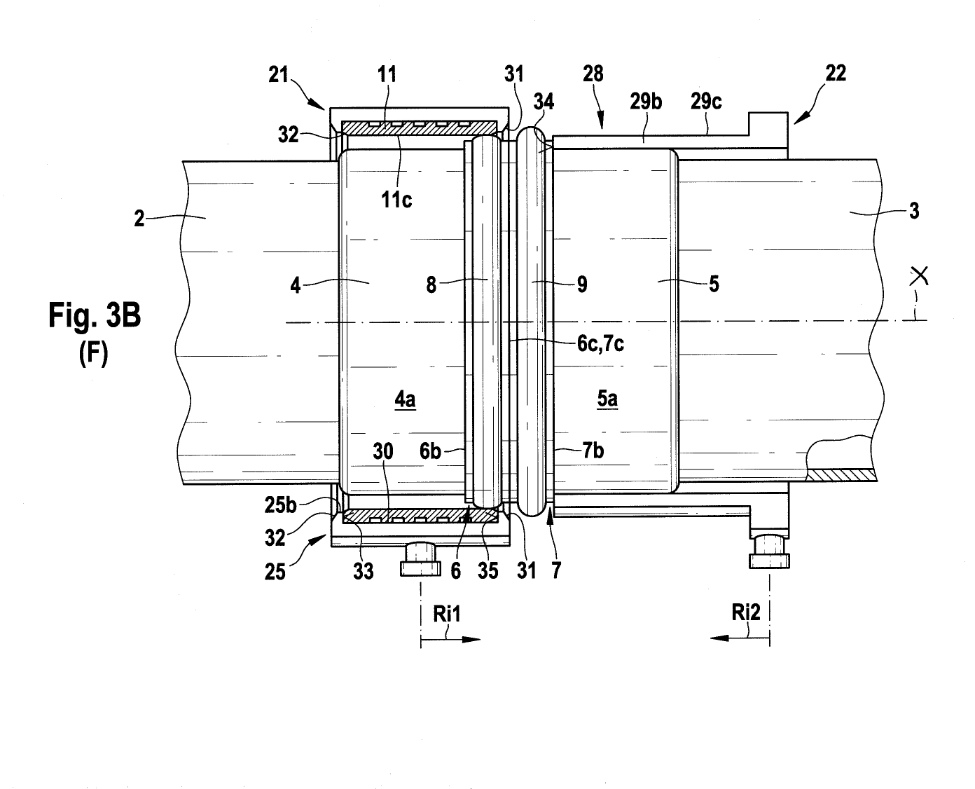

FIG. 3A is a plan view of a use of the tool according to the first embodiment and FIG. 3B shows a view F from FIG. 3A.

The position shown in FIGS. 3A and 3B corresponds to the end position after a first step and thus corresponds to the starting position for a second step when a sleeve 11 is drawn onto flanges 6, 7.

The sleeve 11 is pushed over the first coupling element 4. In so doing, the second O ring 8 is resiliently compressed between the sleeve 11 and the coupling element 4. The sleeve 11 (shown in a sectional view in FIG. 3B for reasons of clarity) is pushed far enough over the coupling element 4 so that the end faces 6c, 7c of the flanges 6, 7 can still be brought into contact.

The shell moulds 25, 28 are preferably made of a resilient material and engage around the sleeve 11 and the annular portion 5a in the radial direction relative to the longitudinal axis X in a manner such that they resiliently hook behind or grip behind the sleeve 11 and the annular portion 5a. This is possible due to the central angle being greater than 180°. Thus, the sleeve 11 and the annular portion 5a are held securely in the radial direction.

The levers 23h, 23i of the parallelogram mechanism 23 are then subjected to a closing pressure to bring the two levers 23h, 23i closer to one another. This causes the retaining means 21 to move towards the pressure means 22 in direction Ri1. In so doing, the bevel 31 firstly comes into contact with the O ring 9 and guides said O ring 9 under an inner side 11c of the sleeve 11 as the sleeve 11 moves further in direction Ri1.

The force required to overcome the counterforce, generated by the deformation of the O ring 9, is applied by a first effective surface 33 of the groove 30 onto the end face 11a of the sleeve 11. A second effective surface 34 is formed by the end face of the annular portion 29b of the pressure means 22. In this respect, the second effective surface 34 acts on the rear side 7b of the flange 7.

The sleeve 11 is then pushed over the O ring 9 until the sleeve 11 occupies an approximately central position relative to the coupling elements 4, 5.

During the movement of the first and second effective surfaces 33, 34 in directions Ri1 and Ri2, they are substantially parallel to one another. The phrase “substantially parallel” is understood as meaning a difference of a few degrees between the two effective surfaces 33, 34, i.e. for example 0.1 to 3°. This effectively prevents a tilting action between the sleeve 11 and the O rings 8, 9, thereby avoiding damage to the O rings 8, 9. Furthermore, a minimum expenditure of force for drawing on the sleeve 11 is required. Torques which arise in the sleeve 11 about an axis normal to the longitudinal axis X can be prevented by the first effective surface 33 and preferably by a third effective surface 35 of the groove 30. The first and third effective surfaces 33, 35 are in this respect also configured to be substantially parallel to one another.

By moving the tool 20 and thus the retaining means 21 and the pressure means 22 in a radial direction relative to the longitudinal axis X, the shell moulds 25, 28 are removed from the sleeve 11 and from the coupling element 5 and the tool can be easily removed.

The sleeve 11 is drawn off analogously to the manner in which it is drawn on:

When the sleeve 11 is in a central position relative to the coupling elements 4, 5, the retaining means 21 can move in direction Ri1 and the pressure means 22 can move in direction Ri2 (starting from the position shown in FIG. 3B). In so doing, the inner side 25b of the shell mould 25 of the retaining means 21 is pushed over the outer side 29c of the annular portion 29b of the pressure means 22.

The following is a brief description of how the first step for drawing the sleeve 11 onto the pipe arrangement 1 is preferably achieved in order to arrive at the position shown in FIGS. 3A and 3B:

The sleeve element 11 is drawn onto the first O ring 8 of the first coupling element 4 in that the tool 20 is rotated about 180° with respect to the position shown in FIGS. 3A and 3B. The second effective surface 34 then rests against the rear side 6b of the flange 6 and acts in direction Ri1 on the flange. The third effective surface 35 then acts on the sleeve 11 in direction Ri2. The bevel 32 on the shell mould 25 then acts as an introduction aid for the O ring 8 to introduce it under the inner side 11c of the sleeve 11.

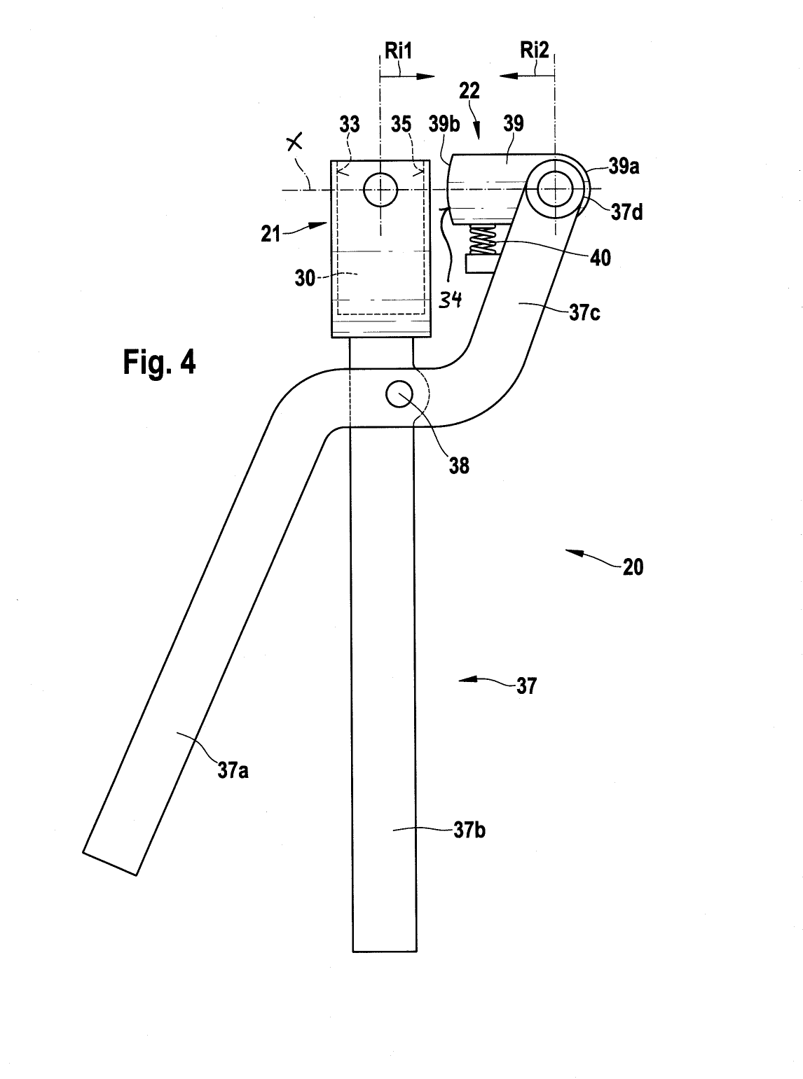

FIG. 4 shows a second embodiment of the tool 20 according to the invention.

In this embodiment, an actuating means 37 for moving the retaining means 21 in direction Ri1 and for moving the pressure means 22 in direction Ri2 is configured according to the principle of pliers.

The actuating means 37 preferably has a lever 37a which is double cranked in opposite directions and a substantially straight lever 37b. The two levers 37a and 37b are interconnected by a hinge 38 such that they can swivel. The portion 37c of the cranked lever 37a facing the pressure means 22 is forked. The forked portion 37c is preferably configured with prongs 37d for clasping the respective coupling elements 4, 5.

The prongs 37d of the forked portion 37c are each provided with a pressure element 39. The pressure element 39 is mounted pivotably on one end of the respective prong 37d by one end 39a. The associated pivot axis is configured to be normal to the longitudinal direction L. The pressure element 39 is provided with a rounded pressure surface at its other end 39b. The longitudinal direction of the pressure element 39 is approximately parallel to the longitudinal direction X of the flanges 6, 7 in the position of use.

Furthermore, a spring element 40 is preferably provided which is attached by one end to the forked portion 37c and by the other end to the pressure element 39. In this respect, the effective direction of the spring element 40 is preferably normal to the longitudinal direction L.

This arrangement, in particular the spring element 40 makes it possible for the sleeve 11 to move relative to the flanges 6, 7, and a tilting action of the sleeve 11 relative to the flanges 6, 7 is prevented. The rounded-off end 39b acts, for example, on the rear side 7b of the flange 7 and thus forms the second effective surface. With its effective surfaces 33 and 35, the groove 30 forms the first and third effective surfaces.

The lever arms 37a and 37b can be of an appropriate length to allow as far as possible a straightforward, low-force drawing procedure of the sleeve 11 onto the O rings 8, 9 and the removal therefrom.

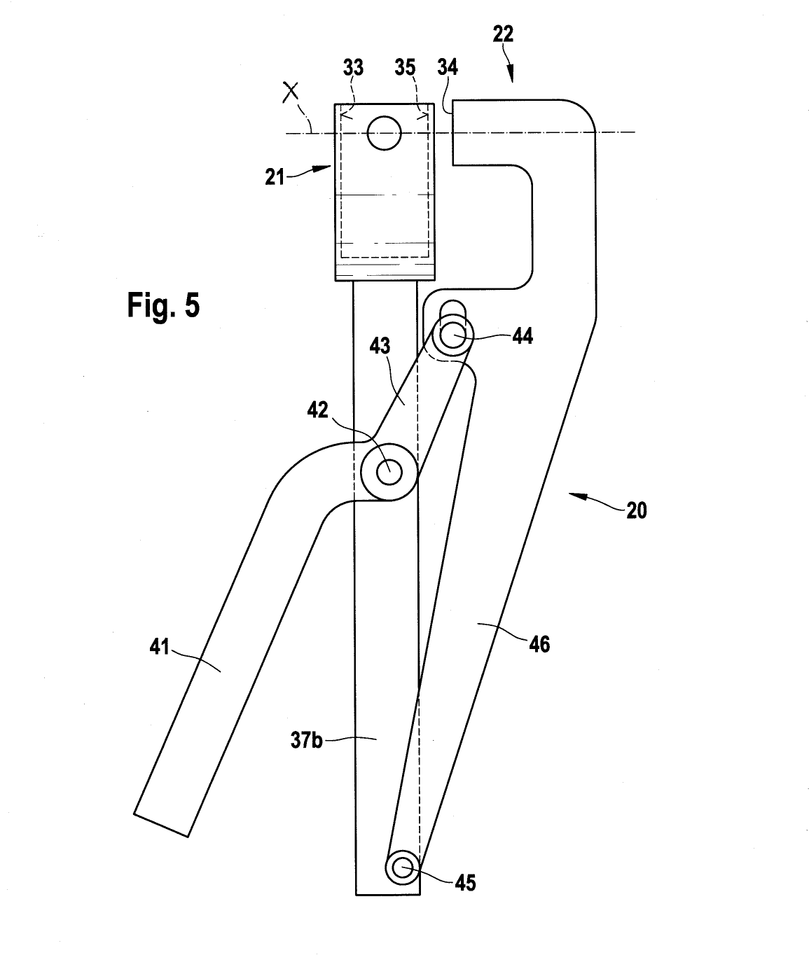

FIG. 5 is a plan view of a third embodiment of the tool 20 according to the invention.

Unlike the second embodiment of FIG. 4, a gear reduction for decreasing the force to be applied for drawing the sleeve 11 on and off is provided. A first lever 41 is mounted pivotably on the substantially straight lever 37b by a hinge 42. A relatively short portion 43 is rigidly connected by one end to the lever 41 and is mounted about the hinge 42, and at its other end it is mounted rotatably and displaceably on a second lever 46 in a second hinge 44. Furthermore, the second lever 46 is mounted pivotably by one end in a third hinge 45. The distance between the first hinge 42 and the second hinge 44 is short compared to the distance between the second hinge 44 and the third hinge 45. When the lever 41 is then actuated, a force which is greater compared to the embodiment of FIG. 4 can be generated on the pressure means 22 in the second direction Ri2.

The large radius of the hinge 45 up to the effective surface 34 which is preferably rounded causes an almost parallel guidance or alignment of the first effective surface 33 to the second effective surface 34.

The invention is not restricted to the specific construction of a tool illustrated in the above figures for drawing a sleeve onto flanges and removing said sleeve therefrom.

Thus, for example, the present inventive concept can also be applied to other coupling connections, and therefore is not restricted to Hydraflow® type couplings.

Furthermore, the shape of the tool according to the invention can be modified in many different ways. For example, it can be provided that the shell mould is configured with a central angle of 360° and is formed in several parts, for example in two parts.

The problem often arises that the pipes 2, 3 are not aligned coaxially to one another with their flanges 6, 7; in other words the flange 7 is initially in an offset arrangement with respect to the longitudinal axis X of the flange 6. Thus, the sleeve 11 cannot be easily pushed over the flanges 6, 7.

Therefore, before the tool 20 is applied, the pipes 2, 3 or the flanges 6, 7 thereof are advantageously positioned relative to one another by a positioning means 50 such that they or the flanges 6, 7 thereof are arranged coaxially along the longitudinal axis X.

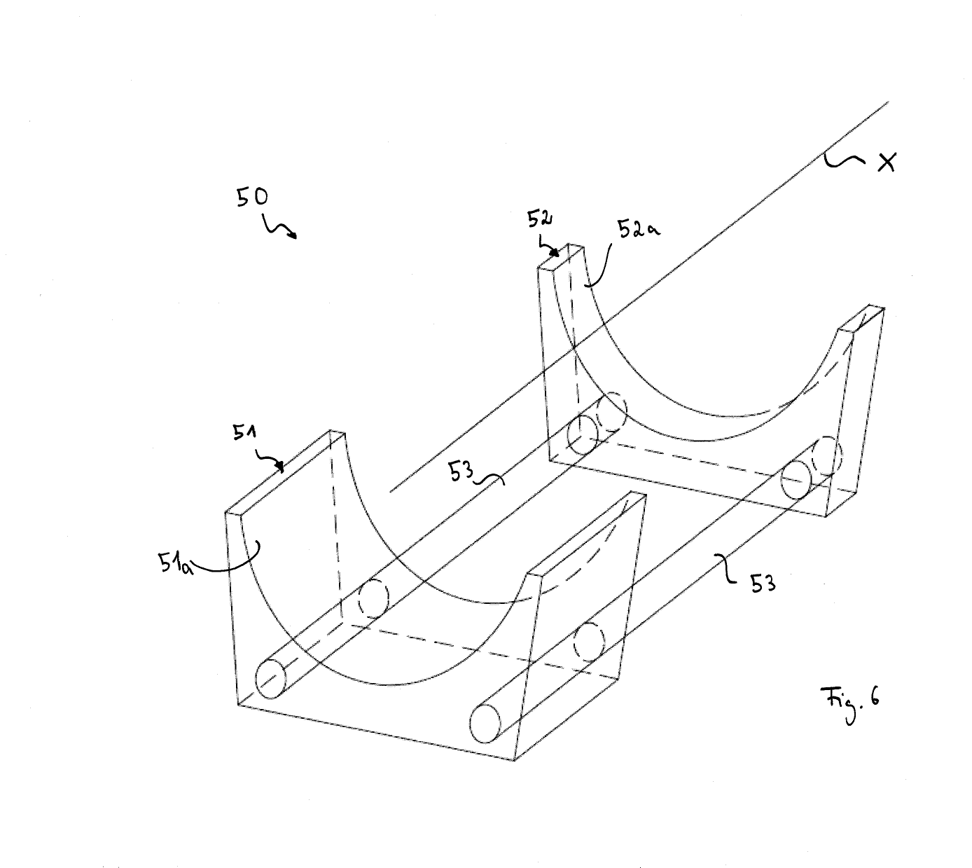

A perspective and very schematic view of a corresponding positioning device 50 according to an embodiment of the present invention is provided in FIG. 6.

The positioning device 50 comprises a first positioning means 51 and a second positioning means 52.

According to the embodiment, the positioning means 51, 52 have a first and second shell mould 51a, 52a. The shell moulds 51a, 52a are held fixedly at a distance from one another, for example by two rods 53 in the longitudinal direction X. The first shell mould 51a is provided to come into contact with the first pipe 2 (or with the coupling element 4 thereof according to a further configuration), while the second shell mould 52a is provided to come into contact with the second pipe 3 (or with the coupling element 5 thereof according to a further configuration). When the shell moulds 51a, 52a are in contact with the respective pipe 2, 3, the pipes 2, 3 or the flanges 6, 7 thereof are aligned along the longitudinal axis X. For reasons of clarity, the pipes 2, 3 and flanges 6, 7 have not been shown in FIG. 6.

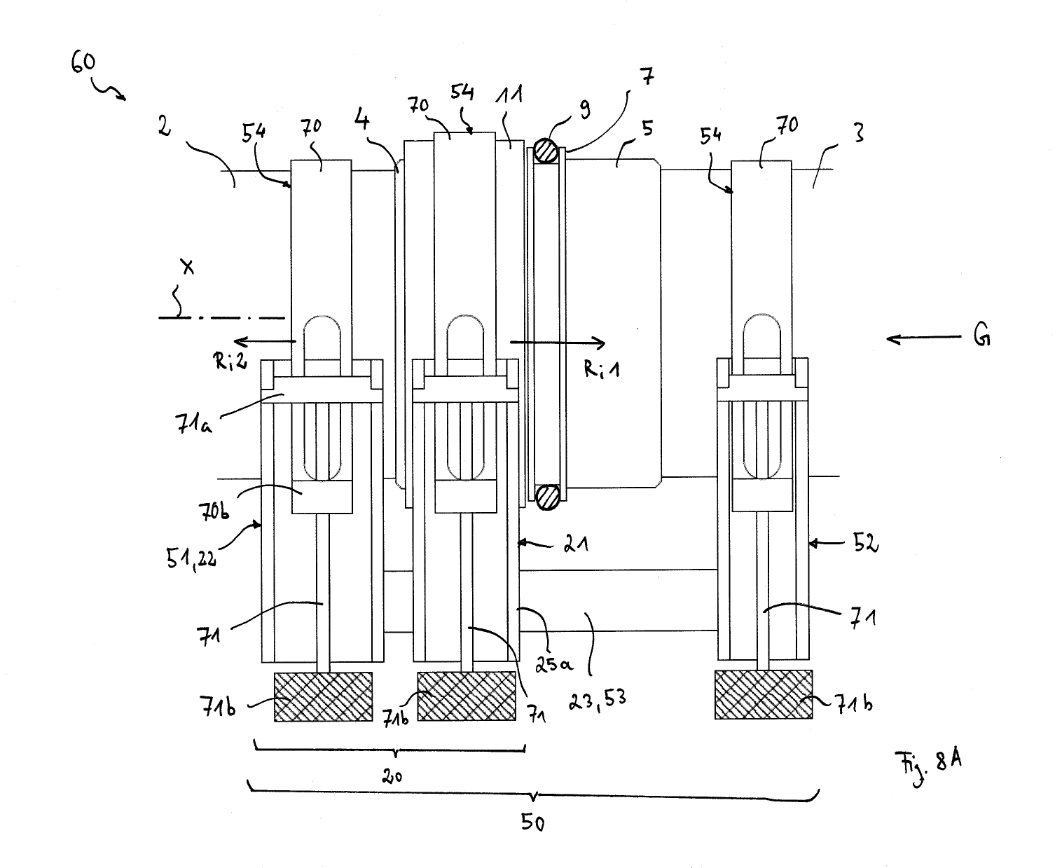

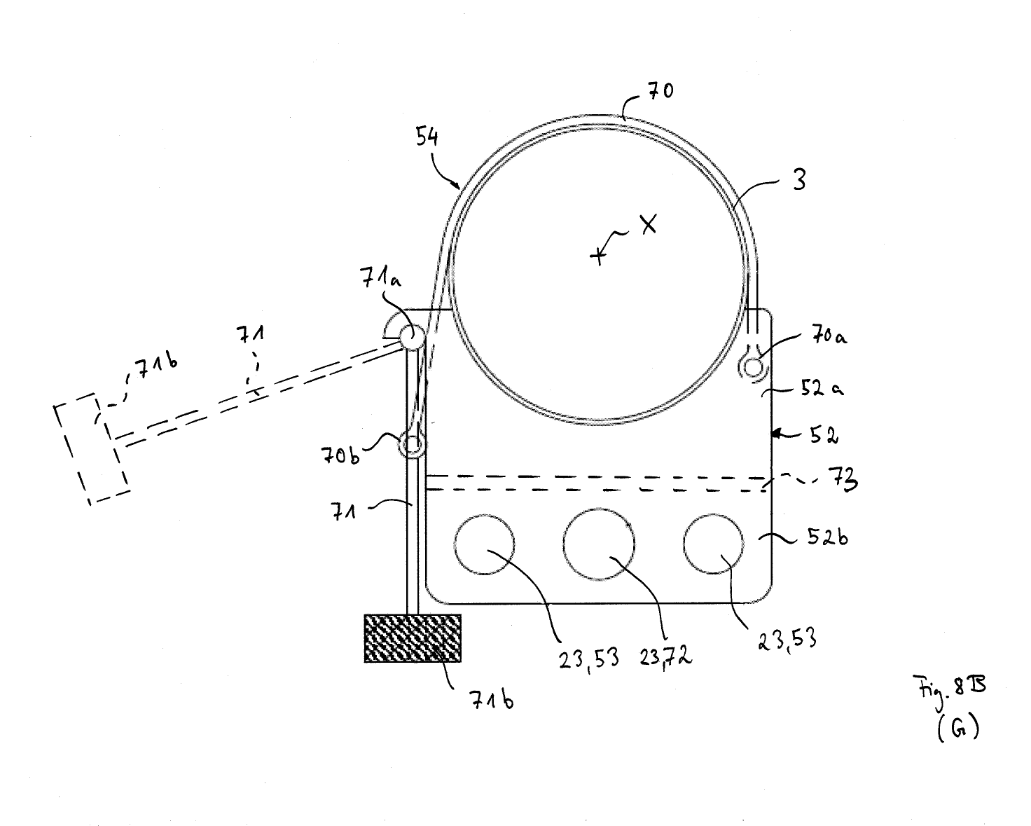

To bring the pipes 2, 3 into contact with the shell moulds 51a, 52a, a tensioning mechanism 54 is provided, which will be described in more detail later on with reference to FIGS. 8A and 8B.

The tool 20 can then be positioned on the sleeve 11 and on the flange 6 and the sleeve 11 can be easily pushed over the flanges 6, 7.

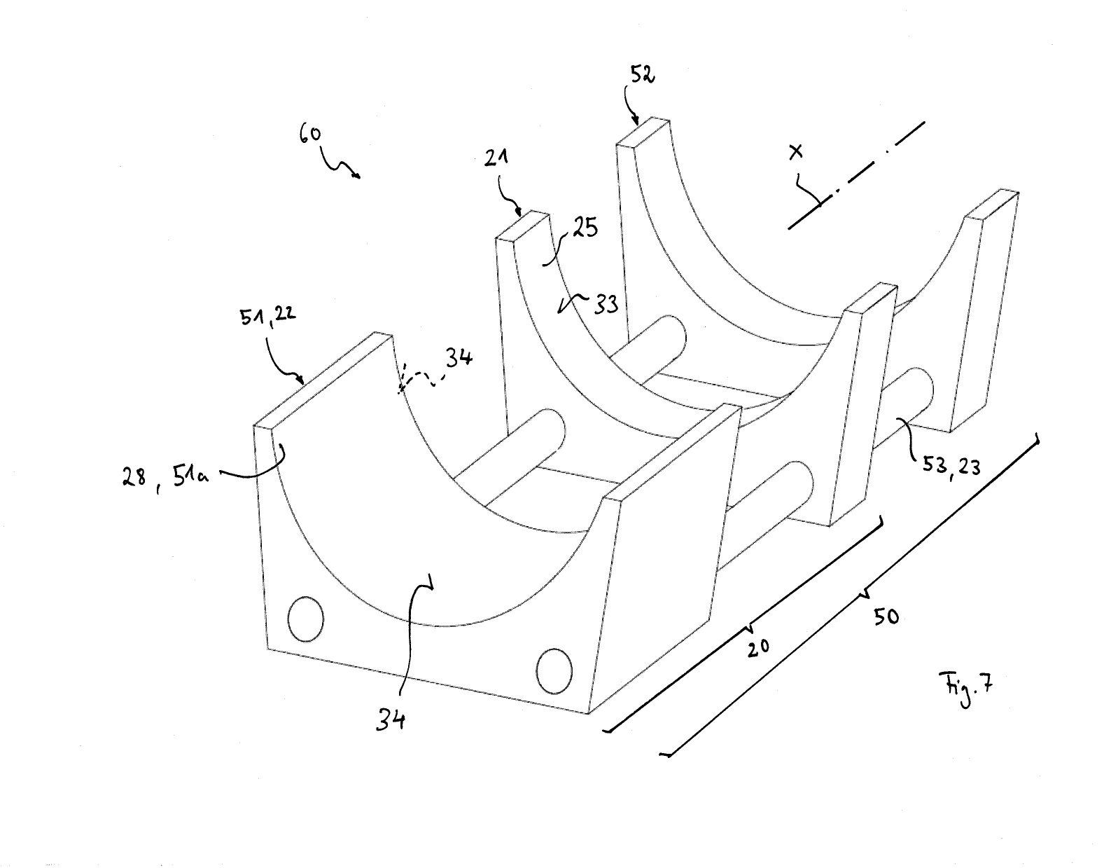

According to a further embodiment, the tool 20 and the positioning means 50 are integrated into one another and form a tool arrangement 60 which is shown in a perspective and very schematic view in FIG. 7.

In the tool arrangement 60, the pressure means 22 of the tool 20 is integrated into the first positioning means 51. For example, the shell mould 51a of the positioning means 51 and the shell mould 28 of the pressure means 22 can be configured as the same part.

The retaining means 21 of the tool 20 is arranged between the first and second positioning means 51, 52. The rods 53 preferably form part of the guide means 23 on which the retaining means 21 is mounted such that it can move in the longitudinal direction X with respect to the pressure means 22 and the first positioning means 51.

FIG. 8A is a side view of a further embodiment of the tool arrangement 60 and FIG. 8B is a view G from FIG. 8A. The tool arrangement 60 according to FIGS. 8A and 8B has been shown in more detail compared to the tool arrangement 60 of FIG. 7.

Each positioning device 51, 52 is formed with a tensioning mechanism 54, as already mentioned in connection with FIG. 6. The retaining means 21 can also comprise a tensioning mechanism 54 of this type. The construction of such a tensioning mechanism 54 will be described in the following by way of example for the second positioning device 52.

As shown in FIG. 8B, the tensioning mechanism 54 comprises a belt 70 which is attached by one end 70a to the shell mould 52a. This attachment can be articulated. At its other end 70b, the belt 70 is attached in an articulated and releasable manner to a lever 71 on the other side of the shell mould 52a or of the pipe 3. The lever 71 is linked to the shell mould 52a at one end 71a. At its other end 71b, the lever 71 is configured with a handle. The lever 71 preferably forms with the belt 70 a top dead centre mechanism.

For positioning the pipe 3, the shell mould 52a is brought into contact with the pipe 3, the belt 70 is looped around the pipe 3 and the end 70b of the belt 70 is joined to the lever 71, for example is hooked into the lever 71. The lever 71 is in the open position shown in dashed lines in FIG. 8B. Thereafter, the lever 71 is brought, for example by muscle power, into its closed position, shown in solid lines in FIG. 8B, in which the belt 70 is positioned tightly around the pipe 3 and presses it firmly against the shell mould 52a. Due to the fact that the lever 71 is moved over a dead centre on its path between the open and closed positions, it is no longer possible for the lever 71 to automatically move out of its closed position. A friction locking is generated along the longitudinal direction X between the belt 70 and the pipe 3 as well as between the shell mould 52a and the pipe 3.

The pressure means 22 can use the friction locking to hold or move the pipe 2 in the second direction Ri2, see FIG. 8A. In this case, the shell mould 51a, see FIG. 7, forms the second effective surface 34 (solid reference numeral line) on its periphery, because the shell mould 51a acts in a friction locking manner on the pipe 2 in the second direction Ri2.

In the same way, the retaining means 21 can use the friction locking to move the sleeve 11 in the first direction Ri1 and thus to push it over the seal 9. For a clearer understanding, the seal 9 is shown in a sectional view in FIG. 8A. In this case, the shell mould 25, see FIG. 7, forms the first effective surface 33 on its periphery, because the shell mould 25 acts in a friction locking manner on the sleeve 11 in the first direction Ri1.

Alternatively, the effective surface 34 (dashed reference numeral line shown in FIG. 7) of the pressure means 22 could also be formed on its end face, in which case the effective surface 34 would act on the flange 6 of the first coupling element 4, as described in connection with FIGS. 3A and 3B (although in FIGS. 3A and 3B, the pipes 2, 3 together with the flanges 6, 7 have been interchanged compared to FIG. 8A). The mentioned friction locking would then not be significant. Accordingly, the retaining means 21 from FIG. 8A can also be configured with an effective surface 33, as described in connection with FIG. 3A. The mentioned friction locking would not be significant here either.

The tool arrangement 60 further comprises a spindle 72, see FIG. 8B, which extends from the first positioning means 51 or pressure means 22 through the retaining means 21 to the second positioning means 52. The retaining means 21, in particular a base portion 25a thereof meshes with the spindle 72. If the spindle 72 is then rotated, for example by an electric motor (not shown), the retaining means 21 travels along the longitudinal axis X, for example in direction Ri1 (with an appropriate rotational direction of the spindle 72), as a result of which the sleeve 11 is drawn onto the seal 9 and the flange 7.

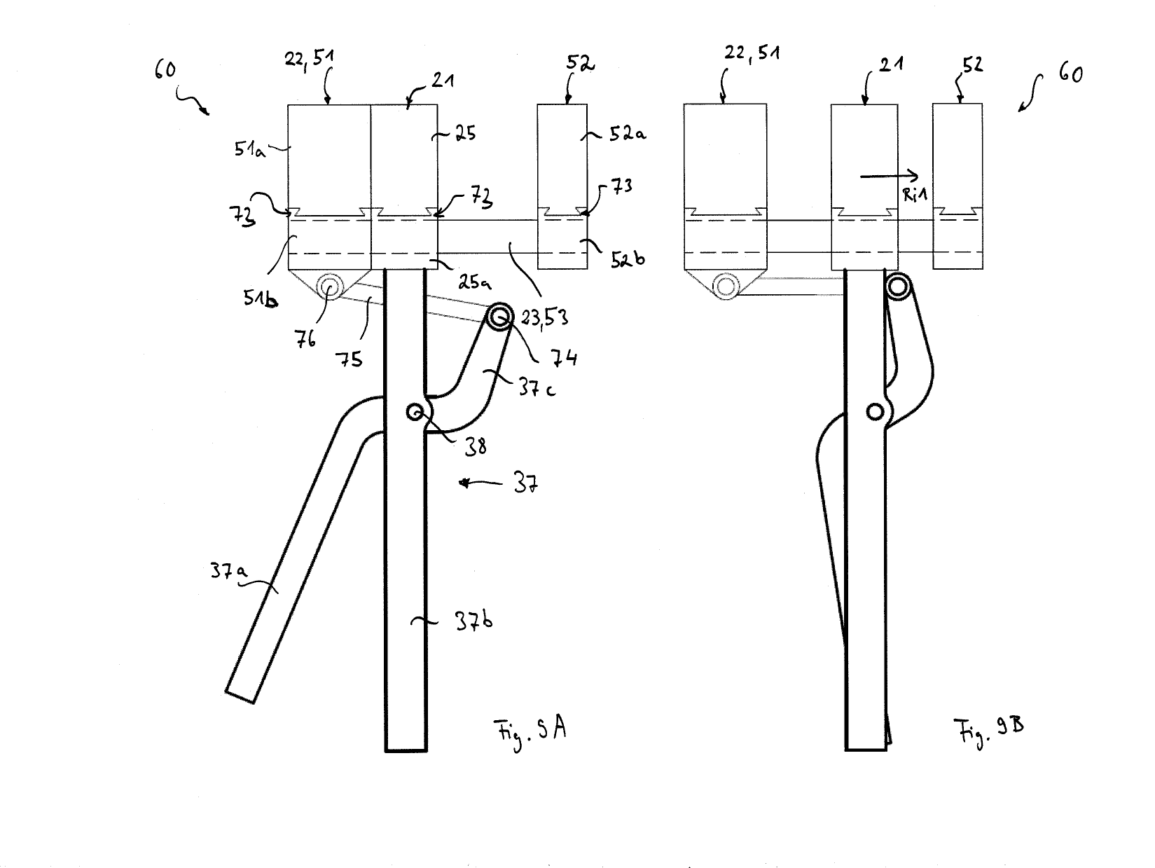

FIGS. 9A and 9B are plan views of a tool arrangement 60 according to a variant compared to the embodiment of FIGS. 8A and 8B. In FIG. 9A, the tool arrangement 60 is in a first position and in FIG. 9B, it is in a second position.

As shown in FIG. 9A, the first positioning means 51 and pressure means 22 and the second positioning means 52 and the retaining means 21 can each be formed with an exchangeable shell mould 51a, 52a, 25 to allow an adaptation to pipes 2, 3 or coupling elements 4, 5 which have different diameters. For this purpose, the shell moulds 51a, 52a, 25 are releasably connected to base portions 51b, 52b and 25a of the first positioning means 51 or pressure means 22, retaining means 21 and second positioning means 52. For example, an appropriate releasable connection is configured as a dovetail joint 73, see also FIG. 8B.

Furthermore, it can be seen from FIGS. 9A and 9B that instead of the mentioned spindle (see FIG. 8B), an actuating mechanism 37 configured in the manner of pliers can also be used to move the retaining means 21 relative to the pressure means 22 and the first positioning means 51. In this case, the end 74 of the portion 37c (which unlike FIG. 4 is not forked) is articulated by a rod 75 with a linking point 76 on the pressure means 22 and the first positioning means 51. If the levers 37a and 37b are pressed towards one another, the retaining means 21 moves in direction Ri1 relative to the pressure means 22 and the first positioning means 51, as a result of which the sleeve 11, see FIG. 8A, is drawn onto the seal 9 and the flange 7.

The embodiments and configurations described above can be combined together in any desired manner. In particular, the developments described here for the tool according to the invention apply accordingly to the tool arrangement and method according to the invention, and vice versa.

For example, the effective surface 34 in the embodiment according to FIG. 5 can be rounded just as it is in the embodiment according to FIG. 4.

What is claimed is:

1. A tool, in particular for the aerospace industry, for drawing a sleeve onto flanges and removing said sleeve from flanges of a pipe arrangement substantially along an axis of the flanges, comprising:
a retaining means which has a first effective surface for acting on the sleeve in a first direction;
a pressure means which has a second effective surface for acting on the pipe arrangement in a second direction opposite the first direction; and
an actuating means for moving the first effective surface in the first direction and for moving the second effective surface in the second direction.

2. The tool according to claim 1, wherein the first and/or second effective surface is/are configured to act on the sleeve and on the pipe arrangement by form locking and/or force locking, in particular by friction locking.

3. The tool according to claim 1, wherein the second effective surface is configured to act on at least one of the flanges and/or on at least one pipe and/or at least on one coupling element of the pipe arrangement.

4. The tool according to claim 1, wherein the first effective surface is curved with an inner radius and/or the second effective surface is curved with an outer radius.

5. The tool according to claim 4, wherein the inner radius of the first effective surface is greater than the outer radius of the second effective surface.

6. The tool according to claim 1, wherein the retaining means comprises a shell mould for at least partially engaging around the sleeve in the circumferential direction thereof.

7. The tool according to claim 1, wherein the pressure means comprises a shell mould for at least partially engaging around the pipe arrangement in the circumferential direction thereof.

8. The tool according to claim 6, wherein a periphery of the shell mould has a central angle of more than 180°.

9. The tool according to claim 6, wherein the shell mould has a plurality of separate effective portions which can be coupled together.

10. The tool according to claim 1, wherein the first effective surface is arranged such that it is always parallel to the second effective surface.

11. The tool according to claim 1, wherein the first effective surface is configured as a contact surface for the sleeve in the first direction and/or the second effective surface is configured as a contact surface for the pipe arrangement in the second direction.

12. The tool according to claim 1, wherein the retaining means is provided with a groove and/or a recess for engagement of the sleeve.

13. The tool according to claim 1, wherein the retaining means has a releasable attachment mechanism for releasably attaching the retaining means to the sleeve.

14. The tool according to claim 1, wherein the pressure means has a releasable attachment mechanism for releasably attaching the pressure means to the pipe arrangement.

15. The tool according to claim 1, wherein the retaining means and/or pressure means comprises a resilient material, in particular a spring steel and/or a plastics material.

16. The tool according to claim 1, wherein the retaining means is bevelled on an inner periphery on at least one of its end faces.

17. The tool according to claim 1, wherein the tool has a guide means, by which the first and second effective surfaces can be moved in the first and second directions.

18. The tool according to claim 1, wherein the guide means has a linear guidance, corresponding linear guide elements being attached to the retaining means and to the pressure means.

19. The tool according to claim 1, wherein the guide means comprises a parallelogram mechanism and/or a slider mechanism which can be actuated by the actuating means, the parallelogram mechanism and/or slider mechanism being coupled with the retaining means and the pressure means.

20. The tool according to claim 1, wherein the actuating means comprises a hydraulic system, a pneumatic system, an electric drive, a mechanical gear reduction and/or handles for the application of force by an operator.

21. The tool according to claim 6, wherein the shell mould of the retaining means and/or of the pressure means is provided to be exchangeable, a dovetail joint for example being provided for the exchange.

22. A positioning device, in particular for the aerospace industry, for positioning two pipes relative to one another for drawing a sleeve onto flanges and removing said sleeve from flanges of the pipes, comprising:
a first positioning means which positions one of the flanges; and
a second positioning means which positions the other flange approximately coaxially to the one flange.

23. A tool arrangement, comprising a tool according to claim 1 and a positioning device according to claim 22.

24. The tool arrangement according to claim 23, wherein the first positioning means and the pressure means are configured to be integrated into one another and the retaining means is preferably provided between the first and second positioning means.

25. The tool arrangement according to claim 23, wherein the first and/or second positioning means comprises a tensioning mechanism, by which the first and/or second pipe or coupling elements of the first and/or second pipe can be tightened against a shell mould of a respective positioning means.

26. The tool arrangement according to claim 25, wherein the tensioning mechanism comprises a belt, a chain, a clamp and/or a lever for tensioning the belt, the chain or the clamp.

27. The tool arrangement according to claim 23, wherein the first and second positioning means are rigidly interconnected by the guide means along the axis, the retaining means being provided to be movable along the axis by the guide means.

28. The tool arrangement according to claim 27, wherein the guide means is configured as a rail which rigidly interconnects the first and second positioning means along the axis, the retaining means being mounted such that it can move on the rail along the axis.

29. The tool arrangement according to claim 27, wherein the retaining means is provided to be movable with respect to the two positioning means along the rail as the result of actuation by the actuating means, in particular by a spindle.

30. A method, in particular for the aerospace industry, for drawing a sleeve onto flanges and removing said sleeve from flanges of two pipes substantially along an axis of the flanges, comprising the following steps:
positioning the flanges along the axis by a positioning device according to claim 22; and
drawing a sleeve onto flanges or removing said sleeve from flanges by a tool according to claim 1.
